(19) United States
(12) Patent Application Publication
(10) Pub. No.: US 2013/0260479 A1
(43) Pub. Date: Oct. 3, 2013

(54) DEVICE AND METHOD FOR DETECTING EXISTENCE OF TARGET BIOMOLECULES IN A SPECIMEN

(71) Applicant: CHANG GUNG UNIVERSITY, Tao-Yuan (TW)

(72) Inventors: Chien Chou, Taipei City (TW); Ying-Feng Chang, Tao-Yuan (TW); Li-Chen Su, Tao-Yuan (TW); Yi-Tsen Lu, Tao-Yuan (TW); Jau-Song Yu, Tao-Yuan (TW); Yu-Sun Chang, New Taipei City (TW); Chao-Sung Lai, Taoyuan City (TW); Ying-Chang Li, Tao-Yuan (TW)

(73) Assignee: CHANG GUNG UNIVERSITY, Tao-Yuan (TW)

(21) Appl. No.: 13/854,339

(22) Filed: Apr. 1, 2013

(30) Foreign Application Priority Data
Apr. 2, 2012 (TW) 101111706

(51) Int. Cl. G01N 21/64

(52) U.S. Cl. CPC G01N 21/6486
USPC 436/501; 422/82.08

(57) ABSTRACT

A detecting device is used for detecting existence of target biomolecules in a specimen with use of antibody complexes labeled with fluorescent molecules. The detecting device includes a capture member coated with capture antibodies for immobilizing the antibody complexes on the capture member when the target biomolecules exist in the specimen, a light emitting unit emitting a beam for exciting the fluorescence molecules to generate a fluorescence signal, and a signal processing unit for receiving the fluorescence signal and determining existence of the target biomolecules in the specimen based upon receipt of the fluorescence signal.

### CROSS-REFERENCE TO RELATED APPLICATION

This application claims priority to Taiwanese Application No. 101111706, filed on Apr. 2, 2012.

### BACKGROUND OF THE INVENTION

1. Field of the Invention

The invention relates to a detecting technique, and more particularly to a device and a method for detecting existence of target biomolecules in a specimen.

2. Description of the Related Art

FIG. 1 and FIG. 2 illustrate a conventional detecting device for detecting existence of target biomolecules 12 (e.g., antigens) in a specimen that is disclosed in Taiwanese patent no. 1342389. The detecting device includes a laser source 21, an optical chopper 22, a lens 24, a multi-mode optical fiber 14 coated with capture antibodies 11, and a signal processing unit 23.

The specimen is first introduced to the multi-mode optical fiber 14 followed by a washing process. If the target biomolecules 12 exist in the specimen, the target biomolecules 12 are bound with the capture antibodies 11. Then, a suspension with antibody complexes 13 is introduced to the multi-mode optical fiber 14 followed by another washing process. Each of the antibody complexes 13 is composed of a metal nanoparticle 131 (e.g., gold nanoparticle) and antibodies 132 that are labeled with fluorescence molecules 133, that are coated on the metal nanoparticle 131, and that are capable of binding with the target biomolecules 12, so that the nanoparticles 131 with the labeled antibodies 132 are immobilized on the multi-mode optical fiber 14 when the target biomolecules 12 exist in the specimen.

In FIG. 1, the laser source 21 is operable to emit a first incident beam 201 with a constant intensity and a wavelength suitable for exciting a localized surface plasmon field of the metal nanoparticle 131, so as to enhance excitation of the fluorescence molecules 133. The optical chopper 22 is used to modulate intensity of the first incident beam 201 for producing a second incident beam 202, such that the florescence signal can be differentiated from the stray light in the background for better detection sensitivity. Intensity of the second incident beam 202 is modulated in a square-wave manner, as shown in FIG. 2. The second incident beam 202 is coupled into the multi-mode optical fiber 14 through a lens 24, and propagates via total internal reflection in the multi-mode optical fiber 14. The second incident beam 202 that propagates in the multi-mode optical fiber 14 results in an evanescent wave to excite the metal nanoparticles 131 immobilized on the fiber surface to produce the localized surface plasmon field. Then, the fluorescence molecules 133 are excited to generate a fluorescence signal with an intensity changing in the square-wave manner. On the other hand, when the target biomolecules 12 do not exist in the specimen, the fluorescence signal will not be generated since the metal nanoparticles with labeled antibodies 132 will not be bound on the fiber surface. The signal processing unit 23 is disposed to receive the fluorescence signal at a side of the multi-mode optical fiber 14, and determines existence of the target biomolecules 12 in the specimen based upon receipt of the fluorescence signal.

In the aforesaid method, detection sensitivity may be limited due to the following reason: intensity fluctuation of the second incident beam 202 may result in noise in the fluorescence signal. In addition, the use of the multi-mode optical fiber 14 disfavors high-throughput detection.

### SUMMARY OF THE INVENTION

Therefore, an object of the present invention is to provide a detecting device that may have better efficiency to excite fluorescence molecules and better detection sensitivity.

According to one aspect of the present invention, a detecting device is adapted for detecting existence of target biomolecules in a specimen with use of antibody complexes. Each of the antibody complexes is composed of a metal nanoparticle and antibodies that are labeled with fluorescence molecules, that are bound to the metal nanoparticle, and that are capable of binding with the target biomolecules. The detecting device comprises:

a capture member coated with capture antibodies that are capable of binding with the target biomolecules;

wherein, when the target biomolecules exist in the specimen, the target biomolecules are bound with the capture antibodies and the antibodies of the antibody complexes so that the antibody complexes are immobilized on the capture member;

a light emitting unit operable to emit a first incident beam directed to the capture member for exciting the fluorescence molecules to generate a fluorescence signal,

wherein the first incident beam is one of a beam with an intensity modulated using an optical chopper, and a beam composed of two mutually correlated parallel linearly-polarized beam components having different frequencies,

wherein a localized surface plasmon field of the metal nanoparticle is excited by the first incident beam to enhance excitation of the fluorescence molecules when the antibody complexes are immobilized on the capture member; and

a signal processing unit disposed to receive the fluorescence signal and operable to determine existence of the target biomolecules in the specimen based upon receipt of the fluorescence signal.

Another object of the present invention is to provide a detection method that may have better efficiency to excite fluorescence molecules and better detection sensitivity.

According to another aspect of the present invention, a method is adapted for detecting existence of target biomolecules in a specimen with use of antibody complexes. Each of the antibody complexes is composed of a metal nanoparticle and antibodies that are labeled with fluorescence molecules, that are bound to the metal nanoparticle, and that are capable of binding with the target biomolecules. The method comprises:

a) introducing the specimen to a capture member coated with capture antibodies that are capable of binding with the target biomolecules, followed by a washing process and introducing the antibody complexes to the capture member;

wherein, when the target biomolecules exist in the specimen, the target biomolecules are bound with the capture antibodies and the antibodies of the antibody complexes so that the antibody complexes are immobilized on the capture member;

b) washing the capture member for removing the unbound antibody complexes and the unbound target biomolecules to result in a treated specimen;

c) using a light emitting unit to emit a first incident beam directed to the capture member for exciting the fluorescence molecules to generate a fluorescence signal,

wherein the first incident beam is one of a beam with an intensity modulated using an optical chopper, and a beam composed of two mutually correlated parallel linearly-polarized beam components having different frequencies,

wherein a localized surface plasmon field of the metal nanoparticle is excited by the first incident beam to enhance excitation of the fluorescence molecules when the antibody complexes are immobilized on the capture member; and

d) using a signal processing unit to receive the fluorescence signal and to determine existence of the target biomolecules in the specimen based upon receipt of the fluorescence signal.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a conventional detecting device for detecting existence of target biomolecules in a specimen;

FIG. 2 is a waveform illustrating intensity of a second incident beam generated using an optical chopper;

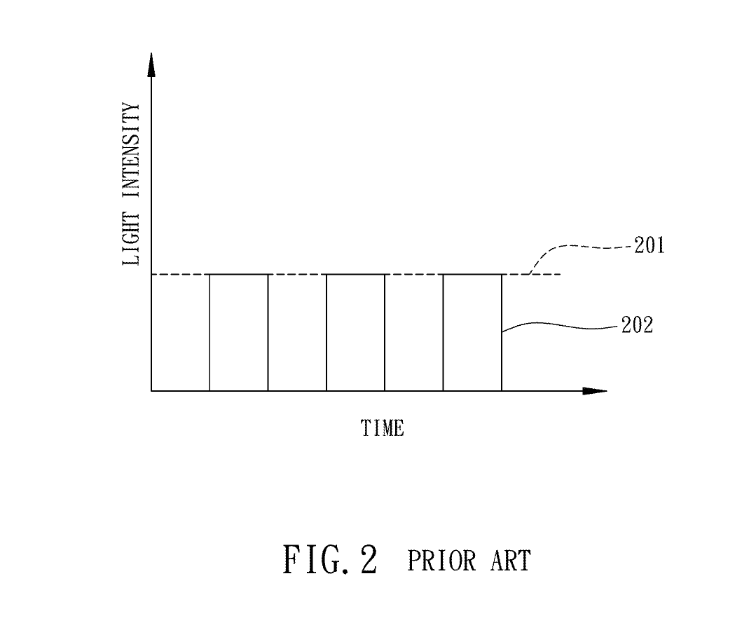

FIG. 3 is a schematic diagram illustrating a first preferred embodiment of the detecting device for detecting existence of target biomolecules in a specimen according to the present invention;

FIG. 4 is a schematic diagram of a well, having a well surface coated with capture antibodies for holding the specimen, of the first preferred embodiment;

FIG. 5 is a block diagram of the first preferred embodiment;

FIG. 6 is a schematic diagram illustrating the first preferred embodiment in a transmissive measurement application;

FIG. 7 is a flow chart illustrating steps of a first preferred embodiment of the method for detecting existence of the target biomolecules in the specimen; and

FIG. 8 is a schematic diagram illustrating a capture member in a second preferred embodiment of this invention.

### DETAILED DESCRIPTION OF THE PREFERRED EMBODIMENTS

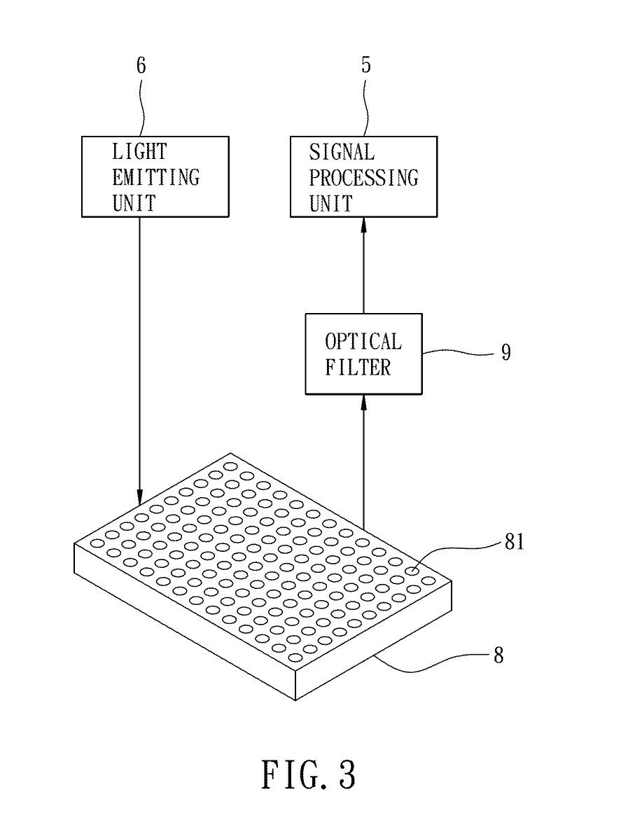

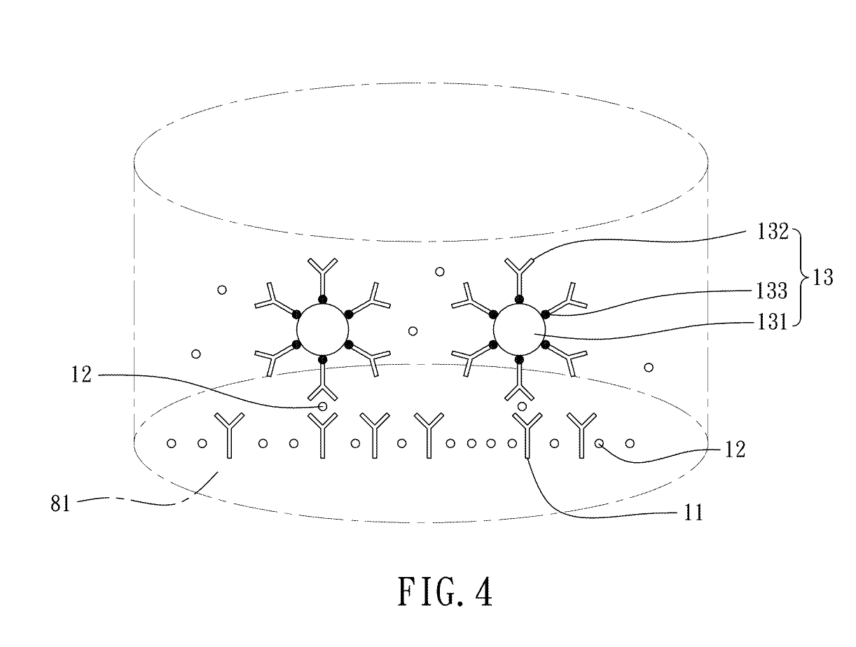

Referring to FIGS. 3 and 4, the first preferred embodiment of the detecting device for detecting existence of target biomolecules 12 (e.g., antigens) in a specimen according to this invention is shown to include a capture member 8 coated with capture antibodies 11, a light emitting unit 6, an optical filter 9, and a signal processing unit 5. In this embodiment, the capture member 8 is a microtiter plate that has a plurality of wells 81 for respectively holding different specimens, so as to facilitate high-throughput and automated detection. Capture antibodies 11 that are capable of binding with the target biomolecules 12 are coated onto well surfaces of the wells 81.

The specimen is first introduced to the microtiter plate followed by a washing process. If the target biomolecules 12 exist in the specimen, the target biomolecules 12 are bound with the capture antibodies 11. Then, a suspension with antibody complexes 13 is introduced to the microtiter plate followed by another washing process. Each of the antibody complexes 13 is composed of a metal nanoparticle 131 (e.g., gold nanoparticle) and antibodies 132 that are labeled with fluorescence molecules 133, that are coated on the metal nanoparticle 131, and that are capable of binding with the target biomolecules 12, so that the nanoparticles 131 with the labeled antibodies 132 are immobilized on the well surfaces of the wells 81 of the microtiter plate when the target biomolecules 12 exist in the specimen. On the other hand, when the target biomolecules 12 do not exist in the specimen, the nanoparticles 131 with the labeled antibodies 132 will be removed from the microtiter plate during the washing process.

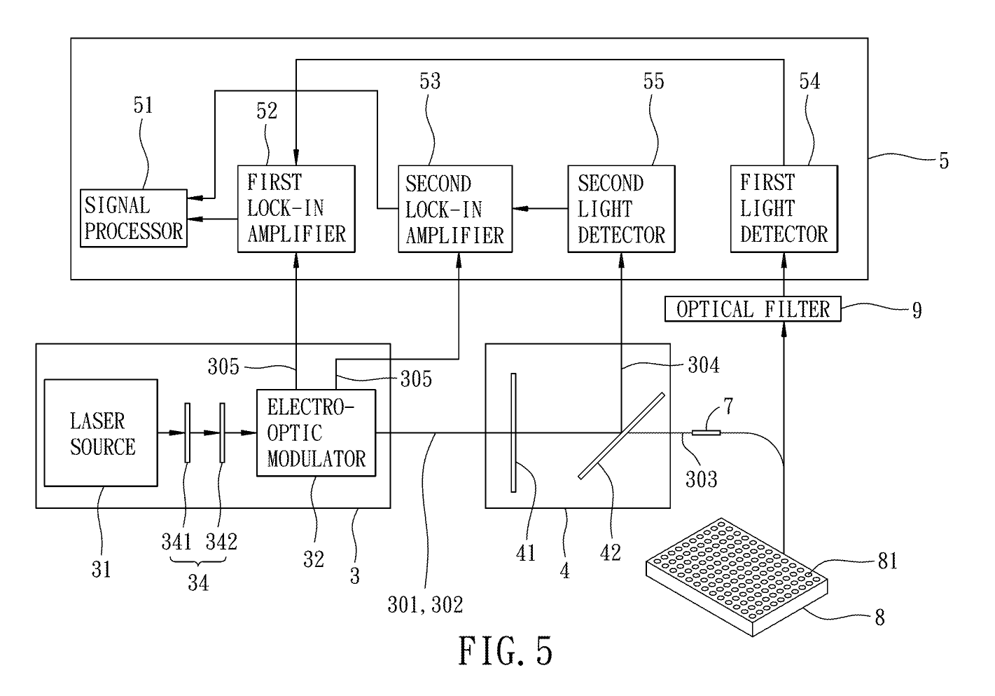

Referring to FIGS. 3 and 5, the light emitting unit 6 is operable to emit a first incident beam 303 directed to the well 81 of the microtiter plate. When the target biomolecules 12 exist in the specimen (i.e., the nanoparticles 131 with the labeled antibodies 132 are immobilized on the well surfaces of the wells 81), the first incident light 303 excites the fluorescence molecules 133 to generate a fluorescence signal. A localized surface plasmon field of the metal nanoparticles 131 is also excited to enhance excitation of the fluorescence molecules 133. It should be noted that, in other embodiments, the metal nanoparticles 131 may be replaced using non-metal nanoparticles, which may result in a weaker fluorescence signal.

In order to enhance differentiation between the fluorescence signal and stray light in the background, the intensity of the first incident beam 303 is preferable to be modulated periodically to generate the periodic fluorescence signal.

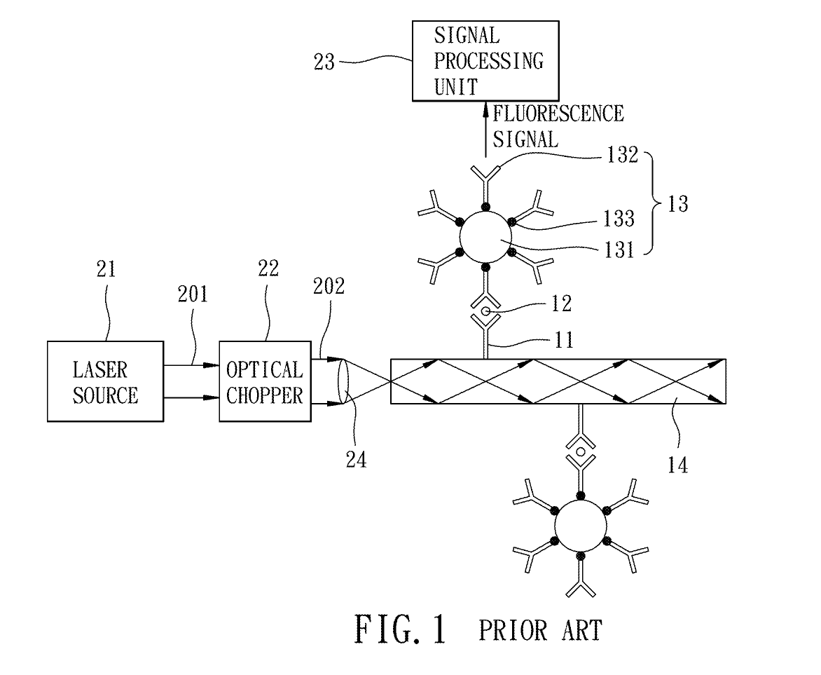

Intensity of the first incident beam 303 may be modulated periodically in several ways. The intensity waveform of the first incident beam 303 generated from the optical chopper 22 as shown in FIG. 1 would be a square wave composed of multiple harmonic waves instead of a sine wave which has a single frequency.

In order to raise measurement sensitivity, the first incident beam 303 may be generated to be a beam composed of two mutually correlated parallel linearly-polarized beam components having different frequencies and propagating along a same optical path as shown in FIG. 5.

The light emitting unit 6 includes a light source 3, a polarization converter 4, and a light guide 7. The light source 3 is used to generate coherent first and second polarized beams 301, 302 that have different frequencies and mutually orthogonal polarization directions and that propagate along a same optical path. In this embodiment, the light source 3 includes a laser source 31, a polarization beam combiner 34, and an electro-optic modulator 32. The polarization beam combiner 34 includes a half-wave plate 341 and a first linear polarizer 342. The laser source 31 is operable to continuously emit a linearly-polarized laser beam with a constant angular frequency ω₀, and the linearly-polarized laser beam passes through the polarization beam combiner 34 to reach the electro-optic modulator 32. The electro-optic modulator 32 is driven by a high-voltage signal with a frequency ω to modulate the linearly-polarized laser beam, so as to generate the first and second polarized beams 301, 302 that respectively have angular frequencies ω₀+ω/2 and ω₀−ω/2, and to generate a reference electrical signal 305 with the frequency ω. The Jones vectors of the electric field E₀ of the first and second polarized beams 301, 302 are described by:

$${E}_{0} = ( \begin{matrix}exp ( i ω t / 2 ) \\ exp ( - i ω t / 2 )\end{matrix} ) {A}_{0} exp ( {iω}_{0} t )$$

where A₀ is an amplitude of the electric field. The first and second polarized beams 301, 302 then pass through the polarization converter 4 for generating the first incident beam 303. In this embodiment, the polarization converter 4 includes a second linear polarizer 41 for adjusting polarization directions of the first and second polarized lights 301, 302 to be mutually parallel, and a beam splitter 42 for splitting the beam through the second linear polarizer 41 into the first incident beam 303 and a second incident beam 304. The light guide 7 is used for directing the first incident beam 303 to the well 81 of the microtiter plate in this embodiment. The light guide 7 may be an optical fiber or a waveguide.

Since the first incident beam 303 is composed of two beams having different frequencies, the excited fluorescence signal thus has an intensity modulated in a harmonic wave with a single frequency due to the optical heterodyne. The fluorescence signal then propagates to the signal processing unit 5 through an optical filter 9. The optical filter 9 allows propagation of the fluorescence signal to the signal processing unit 5, and prevents stray light, which may result from reflection or transmission of the first incident beam 303 by the microtiter plate, from reaching the signal processing unit 5, thereby reducing background noise. In FIGS. 3 and 5, the optical filter 9 blocks the reflection of the first incident beam 303 by the capture member 8. In this embodiment, the optical filter 9 is a dichromatic mirror capable of permitting passage of the excited fluorescence signal and blocking the stray light.

The signal processing unit 5 includes a first light processor having a first lock-in amplifier 52 and a first light detector 54, a second light processor having a second lock-in amplifier 53 and a second light detector 55, and a signal processor 51. The first light detector 54 is used for receiving the fluorescence signal and is operable to generate a first converted electrical signal based upon receipt of the fluorescence signal. The first lock-in amplifier 52 is coupled to the first light detector 54 and the electro-optic modulator 32 to respectively receive the first converted electrical signal and the reference electrical signal 305, and extracts a first electrical signal with less noise from the first converted electrical signal using the reference electrical signal 305 as reference. The second light detector 55 receives and converts the second incident light 304 into a second converted electrical signal. The second lock-in amplifier 53 is coupled to the second light detector 55 and the electro-optic modulator 32 to respectively receive the second converted electrical signal and the reference electrical signal 305, and extracts a second electrical signal with less noise from the second converted electrical signal using the reference electrical signal 305 as reference. The signal processor 51 is coupled to the first and second lock-in amplifiers 52, 53 to respectively receive the first and second electrical signals therefrom, and is operable to determine existence of the target biomolecules 12 in the specimen according to an amplitude ratio of the first and second electrical signals.

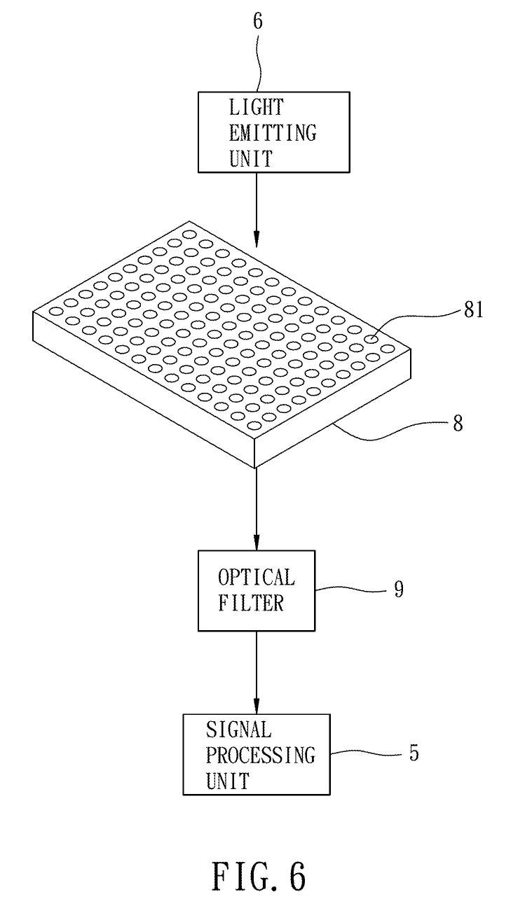

It should be noted that, in the first preferred embodiment, the signal processing unit 5 may receive the fluorescence signal at an open side of the microtiter plate to perform a reflective detection as shown in FIG. 5, or receive the fluorescence signal at a closed side of the microtiter plate to perform a transmissive detection as shown in FIG. 6.

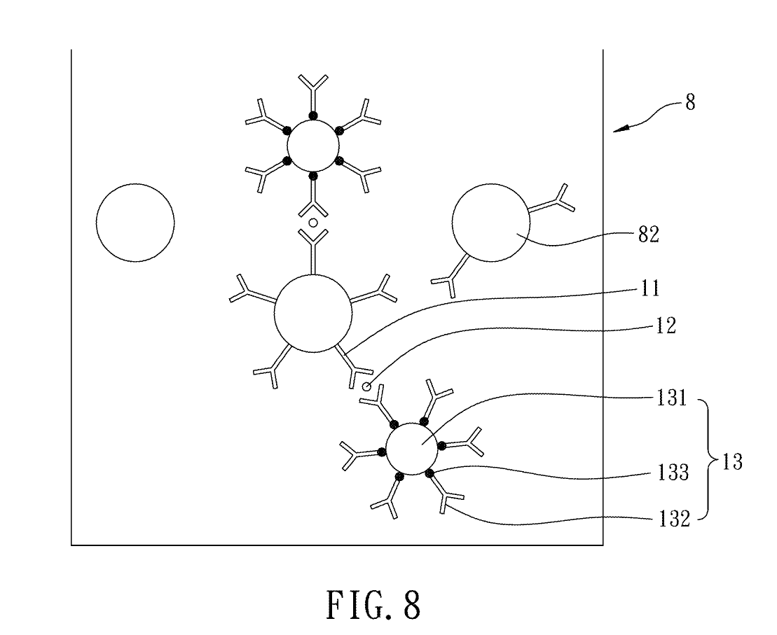

Referring to FIG. 8, a second preferred embodiment of the detecting device for detecting existence of the target biomolecules 12 in a specimen is shown to differ from the first preferred embodiment in that the capture member 8 is a suspension having magnetic microbeads 82 suspended therein. The capture antibodies 11 are coated on the magnetic microbeads 82. Each of the microbeads 82 has a diameter ranging from 1 μm to 10 μm, but may be in a nanometer range in other embodiments. Since the magnetic microbeads 82 are suspended in the suspension, the magnetic microbeads 82 may receive the first incident beam 303 from multiple directions, to thereby obtain better excitation for generation of the fluorescence signal. In addition, the excited fluorescence signal is three-dimensional, which facilitates detection sensitivity of the fluorescence signal. It is noted that, in other embodiments, the magnetic microbeads 82 may be replaced by non-magnetic microbeads, such as polystyrene microbeads.

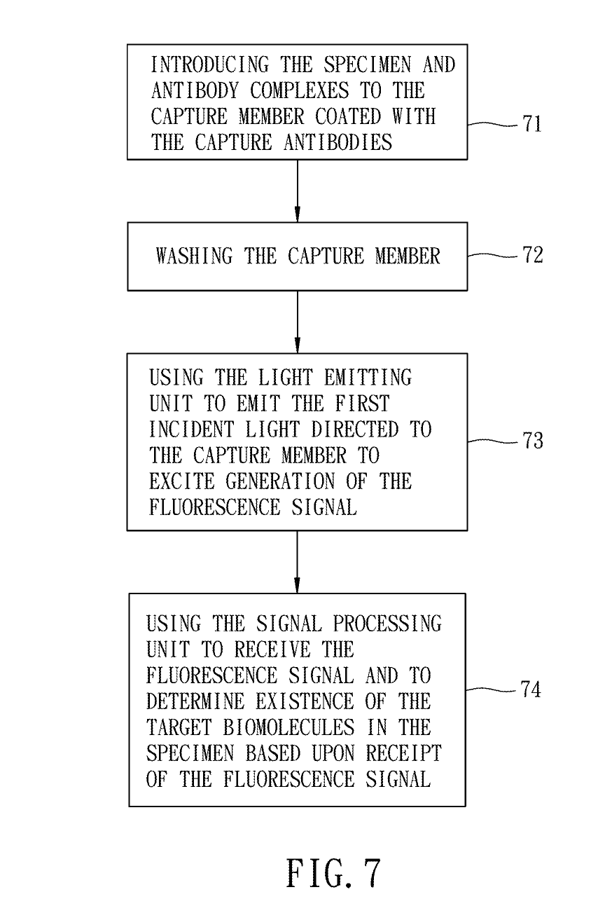

Referring to FIGS. 4, 5, and 7, a first preferred embodiment of the method for detecting existence of the target biomolecules 12 in the specimen is adapted to be implemented using the aforesaid detecting device, and includes the following steps.

Step 71: The specimen is introduced to the capture member 8 coated with the capture antibodies 11 that are capable of binding with the target biomolecules 12, followed by a washing process and introducing the antibody complexes 13 to the capture member 8.

Step 72: The capture member 8 is washed for removing the unbound antibody complexes 13 and the unbound target biomolecules 12 to result in a treated specimen that is immobilized on the surface of the capture member 8. When the target biomolecules 12 exist in the specimen, the treated specimen is formed with the bound capture antibodies 11, the target biomolecules 12, and the antibody complexes 13. On the other hand, the capture antibodies 11 are included in the treated specimen without binding with the target biomolecules 12 and the antibody complexes 13 when the target biomolecules 12 do not exist in the specimen.

Step 73: As shown in FIG. 6, the light emitting unit 6 is used to emit the first incident beam 303 directed to the capture member 8 for exciting the fluorescence molecules 133 to generate the fluorescence signal. Since the first incident beam 303 that excites the localized surface plasmon field of the metal nanoparticles 131 and the fluorescence molecules 133 has a modulated intensity, the excited fluorescence signal also has a modulated intensity.

Step 74: The signal processing unit 5 is used to receive the fluorescence signal and to determine existence of the target biomolecules 12 in the specimen based upon receipt of the fluorescence signal.

Referring to FIG. 8, when the capture member 8 is the suspension having the magnetic microbeads 82, step 72 further includes retreating the washed magnetic microbeads 82 into a suspension to form the treated specimen. The magnetic microbeads 82 are suspended in the retreated suspension to thereby be capable of receiving the first incident beam 303 from multiple directions.

To sum up, according to this invention, the first incident beam 303 is directed to the specimen on the capture member 8 not only to excite the fluorescence molecules but also the localized surface plasmon field of the metal nanoparticles 131, resulting in better efficiency of fluorescence excitation compared to that using the evanescent wave in the prior art. In addition, the intensity of the fluorescence signal is modulated in a harmonic wave with a single frequency by use of the beam composed of polarized beam components with two frequencies, so that the lock-in amplifiers 52, 53 may be used to raise sensitivity of detection.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A detecting device for detecting existence of target biomolecules in a specimen with use of antibody complexes, each of the antibody complexes being composed of a metal nanoparticle and antibodies that are labeled with fluorescence molecules, that are bound to the metal nanoparticle, and that are capable of binding with the target biomolecules, said detecting device comprising:
a capture member coated with capture antibodies that are capable of binding with the target biomolecules;
wherein, when the target biomolecules exist in the specimen, the target biomolecules are bound with said capture antibodies and the antibodies of the antibody complexes so that the antibody complexes are immobilized on said capture member;
a light emitting unit operable to emit a first incident beam directed to said capture member for exciting the fluorescence molecules to generate a fluorescence signal,
wherein the first incident beam is one of a beam with an intensity modulated using an optical chopper, and a beam composed of two mutually correlated parallel linearly-polarized beam components having different frequencies,
wherein a localized surface plasmon field of the metal nanoparticle is excited by the first incident beam to enhance excitation of the fluorescence molecules when the antibody complexes are immobilized on said capture member; and
a signal processing unit disposed to receive the fluorescence signal and operable to determine existence of the target biomolecules in the specimen based upon receipt of the fluorescence signal.

2. The detecting device as claimed in claim 1, wherein said capture member has a well for holding the specimen, and said capture antibodies are coated onto a well surface of said well.

3. The detecting device as claimed in claim 2, wherein said capture member is a microtiter plate.

4. The detecting device as claimed in claim 1, wherein said capture member is a suspension having microbeads suspended therein, said capture antibodies being coated on said microbeads.

5. The detecting device as claimed in claim 1, wherein the first incident beam is the beam composed of two mutually correlated parallel linearly-polarized beam components having different frequencies, and said light emitting unit includes
a laser source operable to continuously emit a linearly-polarized laser beam,
a half-wave plate and a first linear polarizer through which the linearly-polarized laser beam from said laser source passes,
an electro-optic modulator disposed to receive and operable to modulate the linearly-polarized laser beam passing through said half-wave plate and said first linear polarizer to generate coherent first and second polarized beams that have different frequencies and mutually orthogonal polarization directions and that propagate along a same optical path; and
a polarization converter for generating the first incident beam from the first and second polarized beams.

6. The detecting device as claimed in claim 5, wherein said polarization converter includes a second linear polarizer.

7. The detecting device as claimed in claim 6, wherein said polarization converter further includes a beam splitter for splitting beam through said second linear polarizer into the first incident beam and a second incident beam, and said signal processing unit includes:
a first light processor disposed to receive the fluorescence signal and operable to generate a first electrical signal based upon receipt of the fluorescence signal;
a second light processor disposed to receive the second incident beam and operable to generate a second electrical signal according to the second incident beam; and
a signal processor coupled to said first and second light processors so as to receive the first and second electrical signals therefrom and operable to determine the existence of the target biomolecules in the specimen according to the first and second electrical signals.

8. The detecting device as claimed in claim 6, wherein said light emitting unit further includes a light guide for directing the first incident beam to said capture member.

9. The detecting device as claimed in claim 8, wherein said light guide is one of an optical fiber and a waveguide.

10. A method for detecting existence of target biomolecules in a specimen with use of antibody complexes, each of the antibody complexes being composed of a metal nanoparticle and antibodies that are labeled with fluorescence molecules, that are bound to the metal nanoparticle, and that are capable of binding with the target biomolecules, said method comprising:
a) introducing the specimen to a capture member coated with capture antibodies that are capable of binding with the target biomolecules, followed by a washing process and introducing the antibody complexes to the capture member;
wherein, when the target biomolecules exist in the specimen, the target biomolecules are bound with the capture antibodies and the antibodies of the antibody complexes so that the antibody complexes are immobilized on the capture member;
b) washing the capture member for removing the unbound antibody complexes and the unbound target biomolecules to result in a treated specimen;
c) using a light emitting unit to emit a first incident beam directed to the capture member for exciting the fluorescence molecules to generate a fluorescence signal,
wherein the first incident beam is one of a beam with an intensity modulated using an optical chopper, and a beam composed of two mutually correlated parallel linearly-polarized beam components having different frequencies,
wherein a localized surface plasmon field of the metal nanoparticle is excited by the first incident beam to enhance excitation of the fluorescence molecules when the antibody complexes are immobilized on the capture member; and
d) using a signal processing unit to receive the fluorescence signal and to determine existence of the target biomolecules in the specimen based upon receipt of the fluorescence signal.

11. The method as claimed in claim 10, wherein the capture member has a well for holding the treated specimen, and the capture antibodies are coated onto a well surface of the well.

12. The method as claimed in claim 11, wherein the capture member is a microtiter plate.

13. The method as claimed in claim 11, wherein, in step d), the fluorescence signal is received at an open side of the well.

14. The method as claimed in claim 11, wherein the capture member is light-transmissive, and in step d), the fluorescence signal is received at a closed side of the well.

15. The method as claimed in claim 10, wherein the capture member is a suspension having microbeads suspended therein, the capture antibodies being coated on the microbeads.
